(19) United States
(12) Patent Application Publication
(10) Pub. No.: US 2019/0018358 A1
(43) Pub. Date: Jan. 17, 2019

(54) IMAGE FORMING APPARATUS

(71) Applicant: KYOCERA Document Solutions Inc., Osaka (JP)

(72) Inventor: Tomoo MIYAGAWA, Osaka-shi (JP)

(73) Assignee: KYOCERA Document Solutions Inc., Osaka (JP)

(21) Appl. No.: 16/022,746

(22) Filed: Jun. 29, 2018

(30) Foreign Application Priority Data
Jul. 12, 2017 (JP) 2017-135900

(51) Int. Cl. G03G 15/00; G03G 15/20; B41J 11/00; B41J 15/04

(52) U.S. Cl. CPC G03G 15/6555; B41J 15/04; B41J 11/0045; G03G 15/20

(57) ABSTRACT

An image forming apparatus includes a casing, an operation panel, a cover, and a holding section. The operation panel is located on an upper surface portion of the casing. The cover is operable and closable between a closed position and a first open position. The holding section holds the cover in the first open position. The cover includes a cover main body located next to one side of the operation panel and a shaft located on the cover main body in an edge portion near the operation panel. The cover main body is pivotable around the shaft. An inclining angle of the cover main body when the cover is in the first open position is acute relative to the cover main body when the cover is in the closed position.

### INCORPORATION BY REFERENCE

The present application claims priority under 35 U.S.C. § 119 to Japanese Patent Application No. 2017-135900, filed on Jul. 12, 2017. The contents of this application are incorporated herein by reference in their entirety.

### BACKGROUND

The present disclosure relates to an image forming apparatus.

An image forming apparatus with an operation panel located on an upper surface thereof is known. The upper surface includes a central portion and a front edge portion arranged in front of the central portion. The operation panel is located on the central portion. The operation panel receives an operation of a user. The operation panel also displays various screens. The front edge portion is openable. Accordingly, the user can open the front edge portion to remove a jammed sheet from inside of a casing. In other words, the user can open the front edge portion to perform jam removal.

### SUMMARY

An image forming apparatus according to the present disclosure includes an image forming section, a casing, an operation panel, a cover, and a holding section. The image forming section forms an image on a recording medium. The casing internally houses the image forming section. The operation panel is located on an upper surface portion of the casing. The cover is openable and closeable relative to the casing between a closed position and a first open position. The holding section holds the cover in the first open position. The cover includes a cover main body and a shaft. The cover main body is located next to one side of the operation panel. The shaft is located on the cover main body in an edge portion near the operation panel. The cover main body is pivotable around the shaft. An inclining angle of the cover main body when the cover is in the first open position is acute relative to the cover main body when the cover is in the closed position.

### BRIEF DESCRIPTION OF THE DRAWINGS

FIG. 1 is a diagram illustrating a configuration of an image forming apparatus according to an embodiment of the present disclosure.

FIG. 2 is a perspective view illustrating the image forming apparatus according to the embodiment of the present disclosure.

FIG. 3 is a diagram illustrating a first open position of a second cover according to the embodiment of the present disclosure.

FIG. 4 is a diagram illustrating a second open position of the second cover according to the embodiment of the present disclosure.

FIG. 5 is a diagram illustrating an upper surface portion of a casing according to the embodiment of the present disclosure.

FIG. 6 is a perspective view illustrating an engaging section according to fixed embodiment of the present disclosure.

FIG. 7 is an enlarged view of an A portion illustrated in FIG. 5.

FIGS. 8A to 8C are diagrams each illustrating the second cover and a holding section according to the embodiment of the present disclosure.

### DETAILED DESCRIPTION

An embodiment of the present disclosure will be described as follows reference to the drawings. However, the present disclosure is not limited to the following embodiment. Note that elements within the drawings that are the same or equivalent will be referred to with the same reference numbers and description thereof will not be repeated.

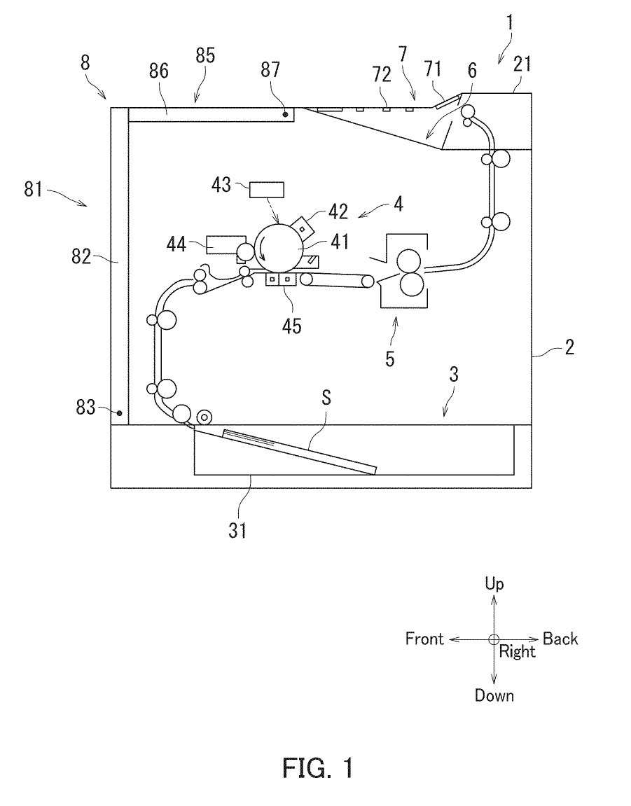

An image forming apparatus 1 according to the embodiment of the present disclosure will be described with reference to FIG. 1. FIG. 1 is a diagram illustrating a configuration of the image forming apparatus 1 according to the present embodiment. As illustrated in FIG. 1, the image forming apparatus 1 is a printer. The image forming apparatus 1 forms an image on a sheet S.

The sheet S is an example of a recording medium according to the present disclosure. Examples of the sheet S include plain paper, copy paper, recycled paper, thin paper, thick paper, glossy paper, and overhead projector (OHP) transparency,

The image forming apparatus 1 includes a casing 2, a sheet feed section 3, an image forming section 4, a fixing section 5, an exit table 6, an operation panel 7, and an open-close section 8. The casing 2 is box-shaped. A portion of a front surface and a portion of an upper surface of the casing 2 are open. The casing 2 internally houses the sheet feed section 3, the image forming section 4, and the fixing section 5. The casing 2 also includes an upper surface portion 21. The exit table 6 and the operation panel 7 are located on the upper surface portion 21.

The operation panel 7 receives an operation of an operator operating the image forming apparatus 1. Specifically, the operation panel 7 includes a display section 71 and an operation section 72. The operation section 72 generates an operation signal according to the operation of the operator. Examples of the operation of the operator include changing a screen displayed by the display section 71.

In FIG. 1, a side of the image forming apparatus 1 that is closer to the operation section 72 than to the display section 71 is defined as front of the image forming apparatus 1, thus defining a front-back direction. A side of the image forming apparatus 1 that is left when the image forming apparatus 1 is viewed in a direction from the front toward the operation panel 7 is defined as left of the image forming apparatus 1, thus defining a left-right direction. An orthogonal direction to both the front-back direction and the left-right direction is defined as an up-down direction.

The display section 71 displays various screens. According to the present embodiment, the display section 71 displays the various screens facing toward the front. The display section 71 includes a liquid-crystal display, for example. Note that the display section 71 functions as the operation section 72 when including a touch panel function.

The sheet feed section 3 feeds the sheet S. In detail, the sheet feed section 3 includes at least one sheet feed cassette 31. A plurality of sheets S may be loaded in the sheet feed cassette 31. The sheet feed cassette 31 feeds at least one sheet S downstream in a conveyance direction of the sheets S.

The image forming section 4 includes an image bearing member 41, a charger 42, an exposure section 43, a developing section 44, and a transfer section 45. The image forming section 4 forms a toner image on the sheet S fed from the sheet feed section 3. The fixing section 5 fixes the toner image to the sheet S. The sheet S with the toner image fixed thereto is ejected to the exit table 6.

The open-close section 8 is openable and closeable relative to the casing 2. The open-close section 8 covers a first opening and a second opening of the casing 2. The first opening is formed in a front surface of the casing 2. The second opening is formed in a front edge portion of an upper surface of the casing 2. The second opening is connected to the first opening. The open-close section 8 includes a first cover 81 and a second cover 85.

The first cover 81 is an example of what may be referred to as a second cover according to an aspect of the present disclosure. The first cover 81 is located on the front surface of the casing 2. The first cover 81 is located on the front surface of the casing 2, in a higher position than the sheet feed cassette 31. The first cover 81 covers the first opening of the casing 2. The first cover 81 includes a first cover main body 82 and a first shaft 83.

The first cover main body 82 is plate-shaped. The first shaft 83 is provided in a lower edge portion of the first cover main body 82. The first shaft 83 is pivotably supported by the casing 2. Accordingly, the first cover main body 82 pivots around the first shaft 83. As a result, the first cover 81 is openable and closeable relative to the casing 2 by pivoting around an axis at the lower edge portion of the first cover 81.

The second cover 85 is an example of what may be referred to as a first cover according to an aspect of the present embodiment. The second cover 85 is located on the upper surface of the casing 2. The second cover 85 is located next to a front side of the operation panel 7 on the upper surface of the casing 2. The second cover 85 covers the second opening of the casing 2. The second cover 85 includes a second cover main body 86 and a second shaft 87.

The second cover main body 86 is an example of a cover main body according to the present embodiment. The second cover main body 86 is plate-shaped. The second cover main body 86 is located next to the front side of the operation panel 7 and is arranged in the same horizontal plane as the operation panel 7.

The second shaft 87 is an example of a shaft according to the present embodiment. The second shaft 87 is located on the second main cover body in an edge portion near the operation panel 7. According to the present embodiment, the second shaft 87 is provided in a back edge portion of the second cover main body 86. The second shaft 87 is pivotably supported by the casing 2. Accordingly, the second cover main body 86 pivots around the second shaft 87. As a result, the second cover 85 is openable and closeable relative to the casing 2 by pivoting around an axis at the back edge portion of the second cover 85.

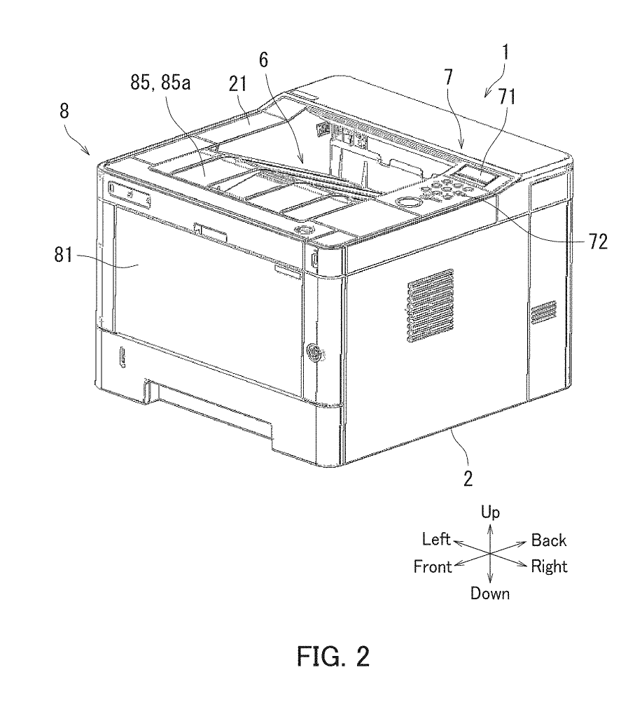

Next, opening and closing of the second cover 85 will be described with reference to FIGS. 2 to 4. FIG. 2 is a perspective view illustrating the image forming apparatus 1. In FIG. 2, the open-close section 8 is closed and the second cover 85 is in a closed position 85a.

As illustrated in FIG: 2, a front edge portion of the second cover 85 is in contact with an upper edge portion of the first cover 81 when the second cover 85 is in the closed position 85a. According to the present embodiment, the second cover 85 can be opened after the first cover 81 is opened. A user opens the second cover 85, for example.

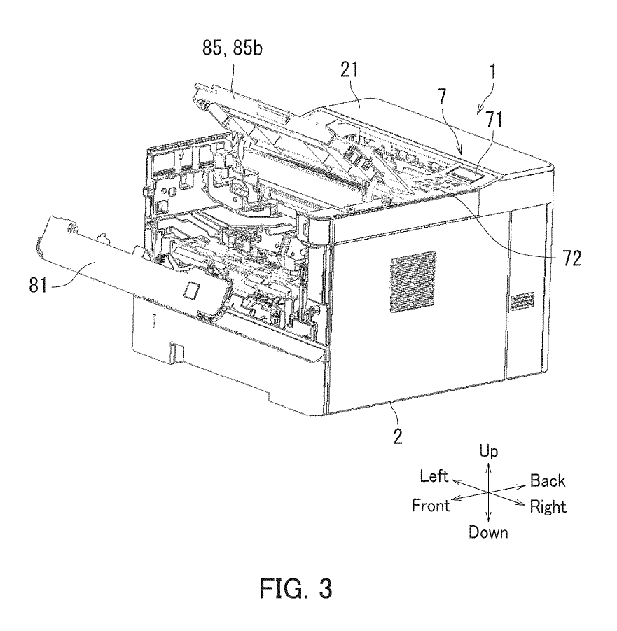

FIG. 3 is a diagram illustrating a first open position 85b of the second cover 85. As illustrated in FIG. 3, the second cover 85 can be opened to the first open position 85b from the closed position 85a illustrated in FIG. 2. The first cover 81 and the second cover 85 are opened for jam removal or toner replacement, for example. Note that jam removal is work to remove a sheet S that has caused a jam inside of the casing 2 from the casing 2.

An inclining angle of the second cover main body 86 when the second cover 85 is in the first open position 85b is acute relative to the second cover main body 86 when the second cover 85 is in the closed position 85a. In other words, the second cover main body 86 slants at an acute angle relative to the upper surface of the casing 2 when the second cover 85 is in the first open position 85b. As a result, the second cover 85 does not obstruct the display section 71 when in the first open position 85b.

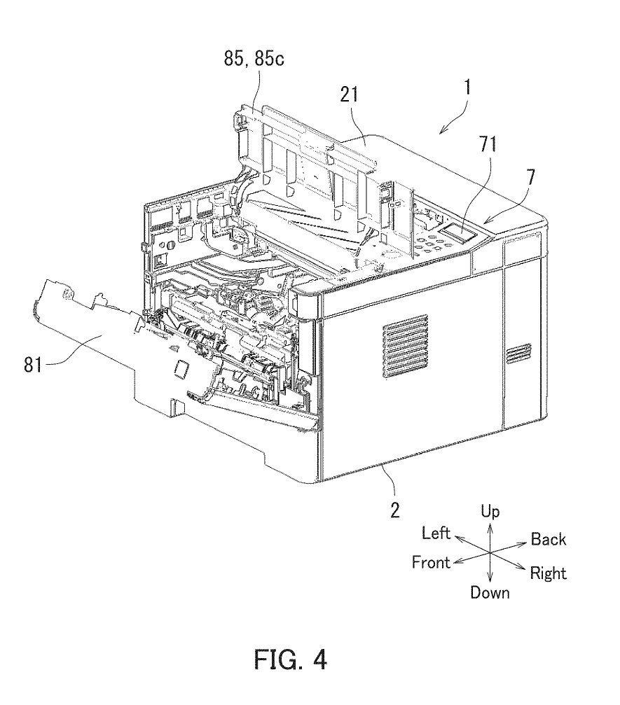

FIG. 4 is a diagram illustrating a second open position 85c of the second cover 85. As illustrated in FIG. 4, the second cover 85 can be further opened from the first open position 85b (FIG. 3) to the second open position 85c. Therefore, the second cover 85 can be opened between the closed position 85a (FIG. 2) and the second open position 85c through the first open position 85b (FIG. 3). The user can further open the second cover 85 from the first open position 85b to the second open position 85c.

In the image forming apparatus 1 of the present embodiment, the second cover 85 obstructs the operation panel 7 when in the second open position 85c, and impedes user viewing of the operation panel 7. The second cover 85 also impedes user operation of the operation panel 7 by obstructing the operation panel 7 when in the second open position 85c.

In the image forming apparatus 1 of the present embodiment as described above with reference to FIGS. 1 to 4, the second cover 85 does not obstruct the operation panel 7 when in the first open position 85b. Accordingly, the user can easily view the operation panel 7 when the second cover 85 is opened to the first open position 85b. In other words, the user can confirm a screen displayed by the display section 71 when performing work such as jam removal or toner replacement. Therefore, the user can perform work efficiently when work instructions are shown on a screen displayed by the display section 71. The user can also easily operate the operation panel 7 when the second cover 85 is opened to the first open position 85b. As a result, the user can operate the operation section 72 to display a plurality of screens showing work instructions in order on the display section 71, for example.

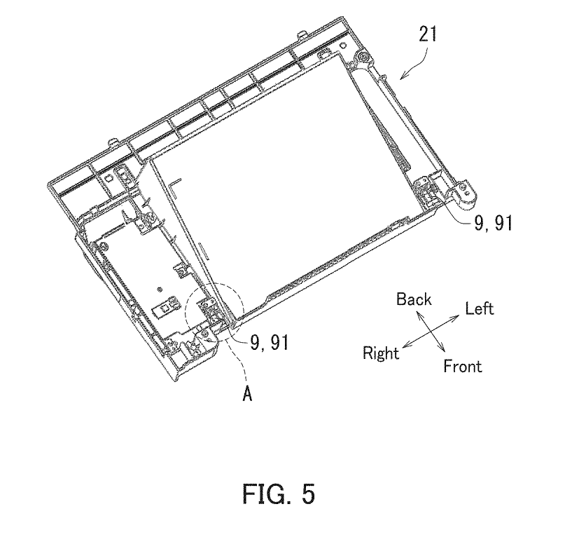

Next, a configuration of a holding section 9 will be described with reference to FIGS. 3 to 7. FIG. 5 is a diagram illustrating the upper surface portion 21 of the casing 2. In detail, FIG. 5 is a perspective view illustrating a lower surface of the upper surface portion 21.

As illustrated in FIG. 5, the image forming apparatus 1 further includes the holding section 9. The holding section 9 holds the second cover 85 in the first open position 85b illustrated in FIG. 3 and in the second open position 85c illustrated in FIG. 4. The holding section 9 includes engaging sections 91 provided on the upper surface portion 21 of the casing 2. According to the present embodiment, the engaging sections 91 are installed on a front edge of the lower surface of the upper surface portion 21.

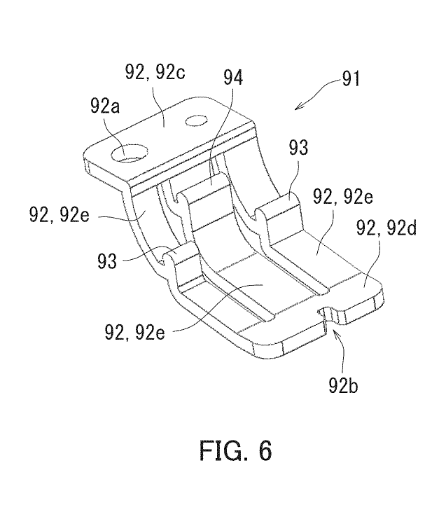

FIG. 6 is a perspective view illustrating an engaging section 91. The engaging section 91 includes main body sections 92, first engaging sections 93, and a second engaging section 94. Examples of materials of the engaging section 91 include resin such as polyacetal.

The main body sections 92 are plate-shaped. Therefore, the main body sections 92 are elastic when the material of the main body sections 92 is resin. The main body sections 92 include a parallel pair of flat sections 92c and 92d. In the following, the flat section 92c may be referred to as a “first flat section 92c”. The flat section 92d may be referred to as a “second flat section 92d”.

The main body sections 92 additionally include three parallel curved surface sections 92e. The three curved surface sections 92e connect the pair of flat sections 92c and 92d. Specifically, the first flat section 92c connects to an edge portion of an arc of each curved surface section 92e. The second flat section 92d connects to another edge portion of the arc of each curved surface section 92e. Each curved surface section 92e is thinly plate-shaped. The first flat section 92c includes a screw hole 92a. The second flat section 92d includes a slit 92b. The slit 92b extends in the same direction as the curved surface sections 92e.

According to the present embodiment, the engaging section 91 includes two first engaging sections 93. The first engaging sections 93 are formed one each on two of the three curved surface sections 92e (examples of first curved surface sections of the present disclosure), located on either side in a direction orthogonal to a longitudinal direction of the curved surface sections 92e. Each first engaging section 93 has the same width as the corresponding curved surface section 92e and protrudes toward a center of the arc of the corresponding curved surface section 92e. Tips of the first engaging sections 93 are arc-shaped. The second engaging section 94 is formed on one of the three curved surface sections 92e (an example of a second curved surface section of the present disclosure), located in the center in the direction orthogonal to the longitudinal direction of the curved surface sections 92e. The second engaging section 94 has the same width as the corresponding curved surface section 92e and protrudes toward the center of the arc of the corresponding curved surface section 92e (a central curved surface section 92e). A tip of the second engaging section 94 is arc-shaped. The second engaging section 94 is formed in a position closer to the first flat section 92c than the first engaging sections 93 are to the first flat section 92c.

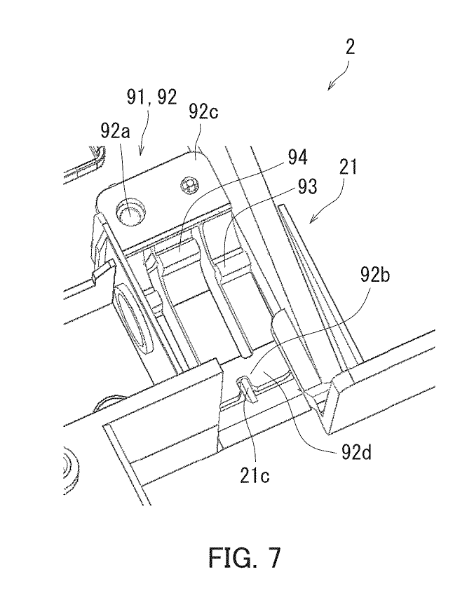

FIG. 7 is an enlarged view of an A portion illustrated in FIG. 5. In detail, FIG. 7 illustrates a case in which an engaging section 91 is yet to be fixed to the upper surface portion 21. As illustrated in FIG. 7, the upper surface portion 21 of the casing 2 includes a ridge 21c. The ridge 21c is formed on the upper surface portion 21. The ridge 21c extends in the same direction as the slit 92b of the second flat section 92d. In other words, the ridge 21c extends in the same direction as the curved surface sections 92e.

In order to install the engaging section 91 in the upper surface portion 21, the slit 92b of the engaging section 91 first engages the ridge 21c. Thereafter, the engaging section 91 is fixed to the upper surface portion 21 by a fixing member pushed into the screw hole 92a of the engaging section 91. As a result, the engaging section 91 is installed in the upper surface portion 21 in a state in which the main body sections 92 can elastically change shape so that the second flat section 92d moves along the ridge 21c. Note that the fixing member is a screw, for example.

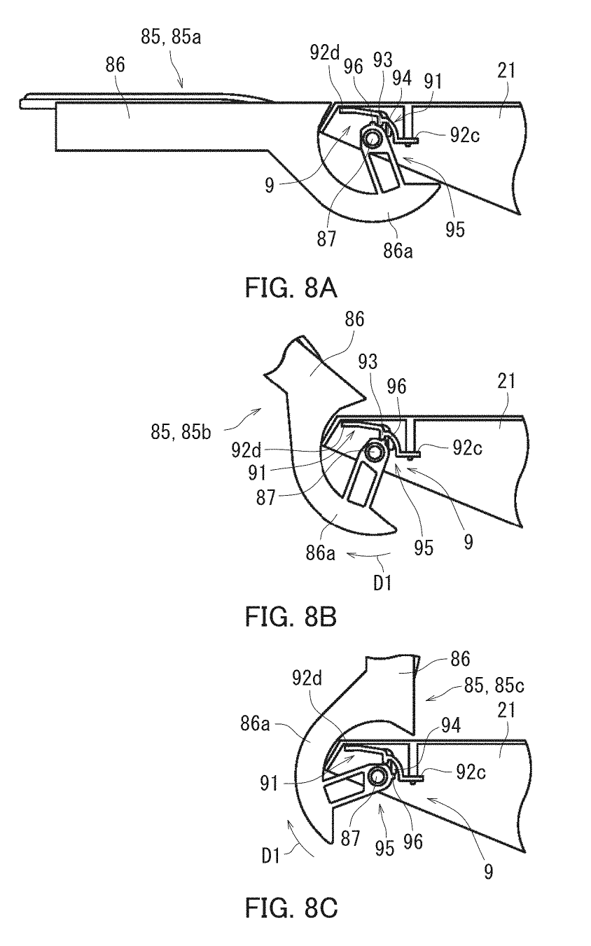

Next, the configuration of the holding section 9 will be further described with reference to FIG. 8A. FIG. 8A is a diagram illustrating the second cover 85 and the holding section 9. The second cover 85 illustrated in FIG. 8A is in the closed position 85a.

As illustrated in FIG. 8A, the holding section 9 further includes a protrusion 95 formed on the second cover main body 86. In detail, the protrusion 95 is formed on the back edge portion of the second cover main body 86. Specifically, the second cover main body 86 includes a curved section 86a. The curved section 86a curves and protrudes in a back direction from a lower surface of the back edge portion of the second cover main body 86 when the second cover 85 is in the closed position 85a. The protrusion 95 extends in a straight line from near a distal end of the curved section 86a toward a center of an arc of the curved section 86a. A distal portion of the protrusion 95 is fixed to the second shaft 87. Accordingly, the protrusion 95 is pivotably supported by the casing 2 through the second shaft 87. The second cover main body 86 pivots around the second shaft 87 with the protrusion 95. The protrusion 95 includes a protuberance 96. The protuberance 96 protrudes toward the engaging section 91. According to the present embodiment, the protuberance 96 is formed on a distal end of the protrusion 95. More specifically, the protrusion 95 has the same width as the engaging section 91 in an axial direction of the second shaft 87, and the protuberance 96 has the same width as the protrusion 95. A tip of the protuberance 96 is arc-shaped. The protuberance 96 engages the first engaging section 93 or the second engaging section 94 when the second cover 85 is open.

Next, opening and closing of the second cover 85 will be further described with reference to FIGS. 8A to 8C. FIGS. 8B and 8C are diagrams illustrating the second cover 85 and the holding section 9. The second cover 85 illustrated in FIG. 8B is in the first open position 85b. The second cover 85 illustrated in FIG. 8C is in the second open position 85c. Note that an arrow D1 illustrated in FIGS. 8B and 8C indicates a pivoting direction of the second cover main body 86 when the second cover 85 is opened.

As illustrated in FIG. 8A, the engaging section 91 does not engage the protrusion 95 when the second cover 85 is in the closed position 85a. Specifically, the engaging section 91 does not engage the protuberance 96 when the second cover 85 is in the closed position 85a. The second cover 85 is placed in the closed position 85a by the weight thereof, for example. The protuberance 96 is placed on a side of the first engaging section 93 toward the flat section 92d when the second cover 85 is in the closed position 85a.

As illustrated in FIG. 8B, the engaging section 91 elastically changes shape by coming into contact with the protrusion 95 (protuberance 96) when the second cover 85 is opened from the closed position 85a to the first open position 85b. Specifically, the first engaging section 93 and the protuberance 96 come into contact. As a result, the protuberance 96 goes over the first engaging section 93 and is engaged by the first engaging section 93. In other words, the protrusion 95 is engaged by the first engaging section 93. Accordingly, the second cover 85 is held in the first open position 85b by the holding section 9. The user can be given the sensation of a click indicating that the second cover 85 is in the first open position 85b.

The inclining angle of the second cover 85 in the first open position 85b is at least 30° and at most 60° relative to the upper surface portion 21 of the casing 2. As a result, the second cover 85 does not obstruct the display section 71 (refer to FIGS. 1 and 3) placed behind the second cover 85 when the second cover 85 is opened to the first open position 85b. Typically, the inclining angle of the second cover 85 in the first open position 85b is 45° relative to the upper surface portion 21.

As illustrated in FIG. 8C, the engaging section 91 elastically changes shape by coming into contact with the protrusion 95 (protuberance 96) when the second cover 85 is opened from the first open position 85b to the second open position 85c. Specifically, the second engaging section 94 comes into contact with the protuberance 96. As a result, the protuberance 96 goes over the second engaging section 94 and is engaged by the second engaging section 94. In other words, the protrusion 95 is engaged by the second engaging section 94. Accordingly, the second cover 85 is held in the second open position 85c by the holding section 9. The user can be given the sensation of a click indicating that the second cover 85 is in the second open position 85c.

According to the present embodiment, the inclining angle of the second cover 85 in the second open position 85c is 90° relative to the upper surface portion 21 of the casing 2. As a result, the open-close section 8 can be opened wider and jam removal can be easily performed in the back part of the casing 2, for example.

The image forming apparatus 1 according to the embodiment of the present disclosure has been described above with reference to FIGS. 1 to 8C. However, the present disclosure is not limited to the above-mentioned embodiment, and may be performed in various manners within a scope not departing from the gist thereof.

For example, in the embodiment of the present disclosure, the engaging sections 91 are elastic. However, the present disclosure is not limited thereto. Each engaging section 91 need only engage the corresponding protrusion 95 when the second cover 85 is in the first open position 85b or in the second open position 85c. For example, the protrusions 95 may be elastic instead of the engaging section 91. For another example, the engaging sections 91 and the protrusions 95 may both be elastic. In either case, each engaging section 91 can engage the corresponding protrusion 95 when the second cover 85 is in the first open position 85b or in the second open position 85c.

In the embodiment of the present disclosure, the image forming apparatus 1 is a printer. However, the present disclosure is not limited thereto. The image forming apparatus 1 need only form an image on the sheet S. The image forming apparatus 1 may be a multifunction peripheral, for example. An example of a multifunction peripheral includes at least two of the following functions: a copy function, a printer function, and a facsimile function.

Note that the drawings are schematic, emphasizing elements of configuration to facilitate understanding thereof. Properties of the elements of configuration in the drawings such as thickness and length may differ from actual properties thereof. Also, shapes and the like of the elements of configuration illustrated in the above embodiment are but one example and are not particularly limited. The elements of configuration may be variously altered within a scope not substantially departing from the effects of the present disclosure.

What is claimed is:

1. An image forming apparatus, comprising:
an image forming section configured to form an image on a recording medium;
a casing configured to internally house the image forming section;
an operation panel located on an upper surface portion of the casing;
a cover that is openable and closeable relative to the casing between a closed position and a first open position; and
a holding section configured to hold the cover in the first open position, wherein
the cover includes:
a cover main body located next to one side of the operation panel; and
a shaft located on the cover main body in an edge portion near the operation panel,
the cover main body is pivotable around the shaft, and
an inclining angle of the cover main body when the cover is in the first open position is acute relative to the cover main body when the cover is in the closed position.

2. The image forming apparatus according to claim 1, wherein
the inclining angle of the cover main body when the cover is in the first open position is at least 30° and at most 60° relative to the cover main body when the cover is in the closed position.

3. The image forming apparatus according to claim 1, wherein
the holding section includes:
a protrusion provided in the cover; and
an engaging section provided in the casing, and
the engaging section includes a first engaging section configured to engage the protrusion when the cover is in the first open position.

4. The image forming apparatus according to claim 3, wherein
the engaging section includes a first curved surface section, and
the first engaging section is provided in the first curved surface section and protrudes toward a center of an arc of the first curved surface section.

5. The image forming apparatus according to claim 4, wherein
the engaging section includes:
a first flat section connected to an edge portion of the arc of the first curved surface section; and
a second flat section connected to another edge portion of the arc of first curved surface section, wherein
the casing includes a ridge extending in an extending direction in which the curved surface section extends,
the first flat section is fixed to the casing,
the second flat section includes a slit extending in an extending direction in which the ridge extends, and
the slit engages the ridge.

6. The image forming apparatus according to claim 3, wherein
the cover is openable and closable between the closed position and a second open position through the first open position, and
the engaging section further includes a second engaging section that engages the protrusion when the cover is in the second open position.

7. The image forming apparatus according to claim 6, wherein
the engaging section includes a first curved surface section and a second curved surface section,
the first engaging section is provided in the first curved surface section and protrudes toward a center of an arc of the first curved surface section,
the second engaging section is provided in the second curved surface section and protrudes toward a center of an arc of the second curved surface section, and
the engaging section has a gap between the first curved surface section and the second curved surface section.

8. The image forming apparatus according to claim 3, wherein
at least one of the protrusion and the engaging section is elastic.

9. The image forming apparatus according to claim 3, wherein
the cover main body includes a curved section on an edge portion near the operation panel, and
the protrusion is provided in the curved section and extends toward a center of an arc of the curved section.

10. The image forming apparatus according to claim 1, wherein
the cover is a first cover,
the image forming apparatus further includes a second cover that is openable and closeable relative to the casing, and
a front edge of the cover main body of the first cover makes contact with the second cover when the first cover is in the closed position.
